(19) United States
(12) Patent Application Publication
(10) Pub. No.: US 2024/0159561 A1
(43) Pub. Date: May 16, 2024

(54) METHOD FOR SUPPLYING AN ELECTRONIC HORIZON FOR AN AUTONOMOUS MOTOR VEHICLE

(71) Applicant: Robert Bosch GmbH, Sturttgat (DE)

(72) Inventors: Alexander Lanin, Pattensen (DE); Katharina Juelge, Sarstedt (DE); Oliver Kamphienkel, Lehrte (DE); Roland Jebtsch, Giesen (DE); Wilfried Feuchter, Kupferzell (DE); Benfamin Vogler, Heilbronn (DE)

(21) Appl. No.: 18/552,238

(22) PCT Filed: Jun. 24, 2022
(86) PCT No.: PCT/EP2022/067324

§ 371 Date: Sep. 25, 2023

(30) Foreign Application Priority Data
Jul. 14, 2021 (DE) 10 2021 207 515.0

(51) Int. Cl. G01C 21/00; B60W 60/00

(52) U.S. Cl. CPC G01C 21/3863; B60W 60/0011

(57) ABSTRACT

A computer-implemented method for supplying an electronic horizon for an autonomous motor vehicle. As part of a first method step, map data of a digital map are processed. As part of a second method step, a position of the autonomous motor vehicle is ascertained and, based on the processed map data, a position-dependent forecast of map elements that are located in front of the autonomous motor vehicle is generated, as a result of which the electronic horizon is supplied. The second method step is performed within a predetermined execution time and regardless of a processing time required for processing the digital map data.

### FIELD

The present invention relates to a computer-implemented method for supplying an electronic horizon for an autonomous motor vehicle.

### BACKGROUND INFORMATION

In the related art, digital map data is processed as part of the navigation of a motor vehicle and/or to supply such data for another driver assistance system. Typically, there are no requirements in terms of functional safety in this case since a driver is responsible for controlling the motor vehicle and/or the motor vehicle is controlled by parts of a relevant system that operate independently of the digital map data. For monitoring a program flow of a safety-critical function, primarily safeguard mechanisms based on cyclical processing of the functionality are provided in the related art. In conventional systems and methods, a function has to be processed in a time-deterministic manner.

Digital map data are supplied in the motor vehicle in the form of an “electronic horizon”. An electronic horizon is intended to refer to a position-dependent forecast of map elements that are located in front of a motor vehicle. By way of example, in navigation systems, place names from digital maps are used for inputting destinations, road topologies are used for calculating routes, and road geometries are used for graphically displaying a route and the surroundings of the motor vehicle. In driver assistance systems, for example, gradients and speed restrictions from digital maps are used for automatic speed control. Hereinafter, a “driver assistance system” should be construed as a system that can also be formed as a navigation system or can comprise a navigation system.

Information on an electronic horizon generated on the basis of digital map data can be used similarly to surroundings data from a sensor of an autonomous motor vehicle as part of automated control of the autonomous motor vehicle. The information that has to be processed, however, typically goes beyond that used in map-based driver assistance systems. Highly automated driving includes, for example, both acceleration/deceleration and steering of motor vehicles. The functional safety requirements are also higher than in a map-based driver assistance system since a driver no longer has to monitor the relevant system continuously.

Map information thus supplements the vehicle sensor system with a significantly larger forecast than is possible with, for example, optical sensors. The limiting factor is whether the information used is up to date. Whereas an environment model is updated from optical sensors at millisecond intervals, digital map data according to the current state of the art require preparation by a data supplier.

There are thus particular requirements when it comes to supplying an electronic horizon for highly automated driving. By way of example, there are functional safety requirements as per standard ISO 26262. Moreover, there are real-time requirements for supplying the electronic horizon to downstream driving functions since defective operation of safety-critical functions is admissible only for an extremely limited period of time. To detect any error, the processing has to be monitored with high temporal resolution.

If digital map data are processed in an embedded system, the digital map data are regularly partitioned. In the process, partitions are geographically determined, for example in the form of a global tile grid. Data volumes associated with the various partitions are generally of different sizes in partitions of the same extent. That is because in practice some map elements are closer together than others, and the map elements are arranged according to a varying density of traffic infrastructure elements. For instance, a partition in a densely populated area having a high number of roads and intersections contains considerably more map elements than a partition of the same size but in a low-population area. Therefore, a deterministic time response cannot be expected when processing individual partitions.

This creates the problem of processing map data in safety-relevant software having real-time requirements. A solution is proposed for the case where there are no explicit minimum requirements for the availability of the electronic horizon. This is possible if the safety goal is a so-called “fail-silent” goal, i.e., if a function is either performed as desired or is not performed at all.

An object of the present invention is to pan improved method for supplying an electronic horizon for an autonomous motor vehicle. This object is achieved by a computer-implemented method for supplying an electronic horizon, having features of the present invention. Advantageous developments of the present invention are disclosed herein. In addition, a computer program product and a machine-readable storage medium are disclosed.

According to an example embodiment of the present invention, a computer-implemented method for supplying an electronic horizon for an autonomous motor vehicle comprises the following method steps. As part of a first method step, map data of a digital map are processed. As part of a second method step, a position of the autonomous motor vehicle is ascertained and, on the basis of the processed map data, a position-dependent forecast of map elements that are located in front of the autonomous motor vehicle is generated, as a result of which the electronic horizon is supplied. The second method step is performed within a predetermined execution time and regardless of a processing time required for processing the digital map data.

The method is based on the notion that conventional monitoring methods cannot be used in the field of autonomous motor vehicle road traffic owing to the complexity of the circumstances, which is why the processing of the digital map data is divided into two threads. A first thread is represented by the first method step, and a second thread is represented by the second method step.

According to an example embodiment of the present invention, in the first thread, the digital map data are processed and then supplied to the second thread. Since digital map data of varying volumes have to be processed depending on the conditions, the first thread is event-controlled and configured in a non-time-deterministic manner. In the first thread, therefore, digital map data are processed unpredictably in terms of time. In the second thread, the electronic horizon is supplied from the digital map data and the position of the autonomous motor vehicle. In the second thread, individual steps are performed within a predetermined execution time, i.e., within a predetermined time frame, that is, in a time-deterministic manner. In other words, the second thread is configured in a time-slice-controlled manner. The first thread can satisfy real-time requirements. For this purpose, the execution time has to be specified down to values in millisecond intervals. By contrast, the processing time in the first thread can be in second or even minute intervals. Both the processing time in the first thread and the execution time of the second thread are, however, not limited to the stated values and/or value ranges. Rather, such indications should be construed as example guide values.

The deterministic part of the method is independent of the execution time of the non-deterministic part since the second method step is performed within a predetermined execution time and regardless of a processing time required for processing the digital map data. Advantageously, this neat division of the functionality can achieve adequate safety in the context of autonomous motor vehicle road traffic. The division into the two above-described threads makes it possible to prioritize time-critical functions as opposed to computationally intensive map pre-preparation.

In one example embodiment of the present invention, before the electronic horizon is generated, a check is carried out as to whether the digital map is up to date. In this case, in a time period that can, for example, be greater than the execution time of the second thread, it can be monitored whether or not the digital map data to be used in the electronic horizon are still up to date. As a result, requirements in terms of the up-to-dateness of the digital map can advantageously be taken into account, for example as part of real-time control of the autonomous motor vehicle.

Both the correct generation of the electronic horizon and the up-to-dateness of the generated electronic horizon may have to satisfy safety-critical requirements, i.e., that any defective execution has to be detected and/or prevented. A defective execution can, for example, result from an error in chronological or logical processing of functions. For example, a processing unit (CPU) may not be clocked accurately enough. However, no detection of errors in the logical and chronological program flow (program flow check, PFC) is performed in the first thread owing to its non-time-deterministic behavior. Since the generation of the electronic horizon is independent of the chronological pre-processing of the digital map data, and the up-to-dateness of the digital map is carried out in the second method step or second thread, a defective generation of the electronic horizon owing to insufficient clocking of the processing unit can advantageously be avoided.

In one example embodiment of the present invention, the processing of the digital map includes converting the digital map. The digital map is converted such that it has a class structure. Advantageously, the digital map is thus in a format that is suitable for generating the electronic horizon.

In one example embodiment of the present invention, the processing of the digital map comprises converting the digital map. The digital map is converted such that it has a path-based structure. Advantageously, a path-based structure allows a horizon graph to be generated in the second method step.

In one example embodiment of the present invention, the generation of the electronic horizon comprises the following steps. A horizon graph consisting of a likeliest path and a plurality of sub-paths is generated. The electronic horizon is generated by combining data from map elements located in the region of the horizon graph to form data packets. It is thus advantageously the case that only relevant elements of the digital map that are located in the region of the horizon graph are used for generating the electronic horizon.

In one example embodiment of the present invention, if there are no processed map data available in the second method step or if the electronic horizon does not need to be supplied, substitute map data are supplied. Processing of the substitute map data similarly to the second method step is carried out within the execution time and regardless of the processing time required for processing the digital map data. There are situations in which an electronic horizon does not have to be generated or cannot be generated since, for example, the vehicle is in a traffic jam and the electronic horizon need not be extended at that moment. In this variant of the method, it is advantageously verified whether an error-free electronic horizon could be supplied, i.e., whether the processing takes place as desired in the second method step even if the electronic horizon cannot or does not have to be generated. Otherwise, a safe state can be induced, for example by way of a safe switch-off. The substitute map data are supplied in a time-deterministic manner during continual data processing.

In one example embodiment of the present invention, the second method step is monitored. Monitoring measures are thus applied only to the second thread. By way of example, a PFC can be carried out in this case. Alternatively or additionally, a so-called “watchdog” can be used. Advantageously, the monitoring verifies that a safe state can be assumed when the execution time is not adhered to and/or when a chronological and/or logical flow is not adhered to. Advantageously, the method can thus satisfy real-time requirements. To execute the second thread in real time, in this case a suitable operating system with real-time capability is required. The first thread does not need an operating system with real-time capability. However, if both threads are running in the same process, they also run on the same operating system. The monitoring measures can also be applied to the processing of the substitute map data.

In one example embodiment of the present invention, a hardware and/or a software lockstep method is used in the first method step. In the case of the first thread, errors in relation to a logical and a chronological flow cannot be detected since the first thread is configured in a non-time-deterministic manner. A potential error in the first thread involves a malfunction of a logic circuit of a program counter. The detection of any such error can advantageously be ensured by a mechanism known as a lockstep. In computing, in particular in processors and microcontrollers, the term “lockstep” describes a method for detecting errors in hardware, said method being achieved by using a plurality of identical or similar units such as CPU cores in multicore processors.

In one example embodiment of the present invention, ascertaining the position of the autonomous motor vehicle involves map matching in which a measured position of the autonomous motor vehicle is allocated to a location in the digital map. In one embodiment, the autonomous motor vehicle is controlled on the basis of the electronic horizon.

In one example embodiment of the present invention, the second method step is cyclically repeated. Advantageously, the electronic horizon is thus cyclically updated.

According to an example embodiment of the present invention, a computer program product comprises commands which, when executed on a computer, cause said computer to carry out a method according to one of the specific embodiments of the present invention. The computer program product can, for example, be stored on a machine-readable storage medium.

Hereinafter, the method for supplying an electronic horizon for an autonomous motor vehicle will be explained in more detail on the basis of the figures.

### BRIEF DESCRIPTION OF THE DRAWINGS

FIG. 1 shows a method for supplying an electronic horizon for an autonomous motor vehicle, according to an example embodiment of the present invention.

FIG. 2 shows a machine-readable storage medium comprising a computer program product for carrying out the method, according to an example embodiment of the present invention.

### DETAILED DESCRIPTION OF EXAMPLE EMBODIMENTS

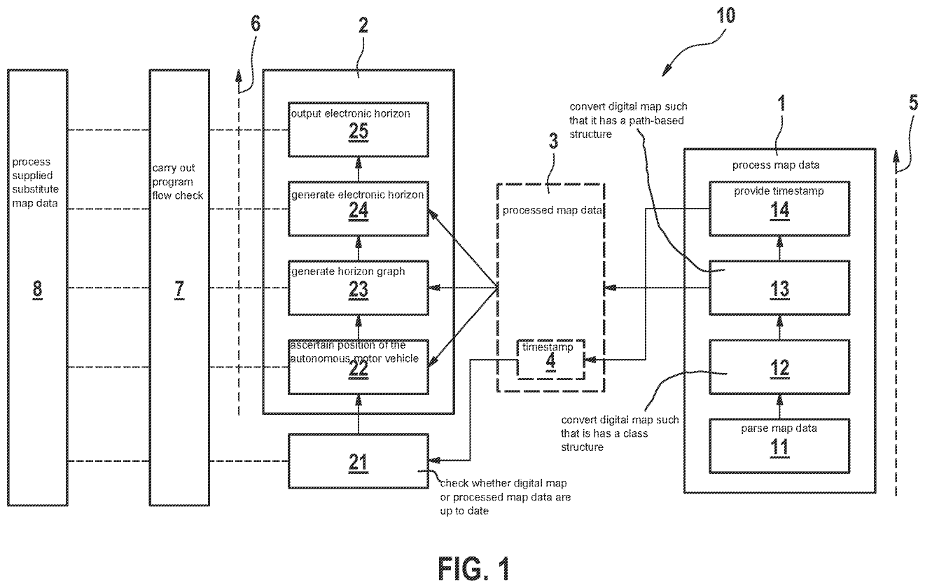

FIG. 1 schematically shows a computer-implemented method 10 for supplying an electronic horizon for an autonomous motor vehicle.

As part of the first method step 1 of the method 10, which step represents the first thread, map data of a digital map are processed. The map data can be received first and are, for example, in navigation data standard (NDS) format. The NDS format is a standardized format for map databases in navigation systems that is developed jointly by car manufacturers and suppliers on the basis of quality requirements from the automotive industry. However, the map data can also be in a different format.

The first method step 1 can comprise a plurality of steps 11, 12, 13, 14. The first method step 1 is performed within the processing time 5. The processing time 5 is dependent on a volume of the map data. In a first optional step 11, the map data can be parsed. Parsing refers to the breaking down and conversion of data into a format that is more suitable for further processing. In a second optional step 12, the digital map is converted such that it has a class structure. In a third optional step 13, the digital map is converted such that it has a path-based structure. Any tile partitioning of map data can be eliminated between the second step 12 and the third step 13, for example. In addition, it can be determined, for example before the third step 13, whether just one part of the map data is to be used for generating the horizon, in which case only the relevant part of the map data is converted in the third step 13. In an optional fourth step 14, the processed map data 3 can be provided with a timestamp 4, thereby making it possible to check whether the digital map is up to date. Alternatively, however, the digital map can be provided with a timestamp 4, for example, at a time at which the digital map is received. Alternatively, the digital map may have already been provided with a timestamp 4 beforehand by a supplier of the digital map. In both of the above alternatives, the fourth step 14 is omitted in each case.

After the first method step 1, it can be checked in a first optional step 21 whether the digital map or the processed map data is/are up to date. By way of example, the first step 21 can be performed at intervals that are greater than the execution time 6 of the second thread, which execution time may be predetermined by the real-time requirements. The timestamp 4 is used as part of the first step 21. In the illustrated specific embodiment of the method 10 in FIG. 1, the timestamp 4 of the processed map data 3 is used, the processed map data having been provided with said timestamp as part of the fourth step 14. The timestamp 4 includes information on a time t 1 at which the map data were up to date. In the example shown, the time t 1 corresponds to the time at which the processed map data 3 were provided with the timestamp 4. It is checked whether the time t 1 deviates from a system time to by a predefined length of time Δt, which may be in the minute range, for example. If this is the case, the map data or the digital map is/are no longer deemed up to date. In that case, the map data are not used to generate the electronic horizon. The map data not being up to date can be caused, for example, by the map delivery service being unavailable or by interference on the communication path between the map delivery service and a system carrying out the method 10. Thus, the availability of map data is an event that triggers the second thread. To ensure up-to-dateness, a connection to a map delivery service, as needed depending on the application, is required.

The map data are fully covered by timestamps 4; in other words, when parts of the digital map are processed separately, they are each provided with their own timestamps 4. The up-to-dateness is checked in the second thread only after the processing in the first thread. By way of example, the timestamp can be issued once per tile partition and then applies to all the map elements included in the tile partition. When transitioning into a non-partitioned data model having a path-based structure, it may be that map elements are compiled from a plurality of tile partitions, rendering a plurality of timestamps 4 valid. In this case, for example, an oldest timestamp 4 can be used in order to ensure up-to-dateness even in the case of the oldest timestamp 4.

The second method step 2, which represents the second thread, can comprise a plurality of steps 22, 23, 24, 25. The second method step 2 is performed within the predetermined execution time 6. In a second method step 22, the position of the autonomous motor vehicle is ascertained. In this case, for example, the map matching method can be used, although this is not essential. In a third and a fourth step 23, 24, the electronic horizon is generated. In this case, a horizon graph is generated using a graph generator in the third step 23, and the electronic horizon is generated in the fourth step 24, as a result of which the electronic horizon is supplied. In graph theory, a graph is an abstract structure that describes objects using a path set and a node set. The horizon graph has a likeliest path and a plurality of sub-paths. The paths extend along a road network. The graph generator determines a road network portion that is located in a region in front of the ascertained position of the autonomous motor vehicle and determines the horizon graph on the basis of the portion. The horizon graph thus merely comprises portions of paths. By cyclically repeating the method 10 or the second method step 2, the road network portion relevant for the horizon graph can be updated. The electronic horizon is generated by combining data from map elements located in the region of the horizon graph to form data packets. The data packets can also be referred to as protocol data units (PDUs). The PDUs can be compiled into a Message on Bus. In a fifth optional step 25, the electronic horizon is output. By way of example, the electronic horizon can be output in Advanced Driver Assistance System (ADASIS) format, which is a standardized data exchange protocol for automated driving applications. The electronic horizon is then available to the autonomous motor vehicle for automatically controlling said vehicle.

The method 10 is based on dividing the processing of map data into two threads: the first thread, which has non-deterministic time behavior, processes the map data and makes them available to the second thread; and the second thread, in which the electronic horizon is generated. The second thread has time-deterministic behavior and can satisfy real-time requirements when it is additionally monitored. By way of example, a program flow of the second thread can be checked (PFC) for the purpose of the monitoring. Alternatively, a watchdog can also be used for the monitoring. By way of example, FIG. 1 shows the case in which a PFC 7 is carried out for monitoring the second thread. In this case, the individual steps 22, 23, 24, 25 of the second method step 2 are monitored. As shown in FIG. 1, it can also be monitored whether or not the digital map or the processed map data 3 have been checked to see if they are up to date. Such monitoring measures cannot be applied to the first thread. In this case, lockstep methods are possible, as already explained above. Systematic errors in the program flow of the first thread can be prevented in that the program flow of the first thread is not influenced by external inputs.

If there are no ready-processed map data available or an electronic horizon does not need to be supplied, then as part of an alternative method step 8, processing of supplied substitute map data similarly to the second method step 2 can be carried out within the execution time 6 and regardless of the processing time 5 required for processing the digital map data. Optionally, the processing of the substitute map data can also be monitored. By way of example, FIG. 1 shows that a PFC 7 is carried out for this purpose, but a watchdog may be used alternatively or additionally.

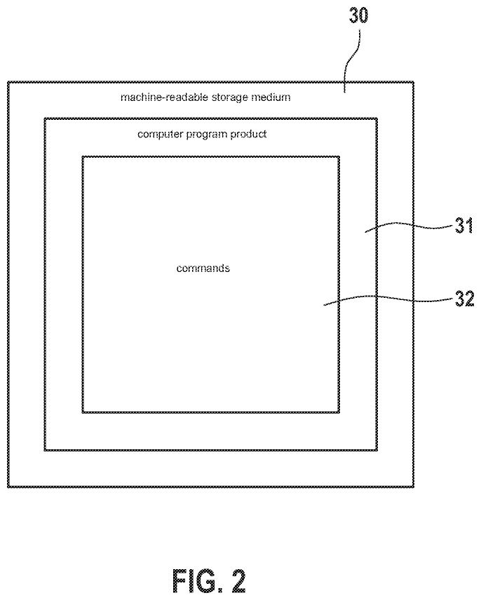

FIG. 2 schematically shows a machine-readable storage medium 30. A computer program product 31 is stored on the machine-readable storage medium 30. The computer program product 31 comprises commands 32 which, when executed on a computer, cause said computer to carry out the method 10 according to FIG. 1.

1-12. (canceled)

13. A computer-implemented method for supplying an electronic horizon for an autonomous motor vehicle, the method comprising the following steps:
processing digital map data of a digital map as part of a first method step; and
ascertaining a position of the autonomous motor vehicle and generating, based the processed digital map data, a position-dependent forecast of map elements that are located in front of the autonomous motor vehicle as part of a second method step, as a result of which the electronic horizon is supplied;
wherein the second method step is performed within a predetermined execution time and regardless of a processing time required for the processing of the digital map data.

14. The method as recited in claim 13, wherein, before the electronic horizon is generated, a check is carried out as to whether the digital map is up to date.

15. The method as recited in claim 13, wherein the processing of the digital map data includes converting the digital map, wherein the digital map is converted such that it has a class structure.

16. The method as recited in claim 13, wherein the processing of the digital map data includes converting the digital map, wherein the digital map is converted such that it has a path-based structure.

17. The method as recited in claim 13, wherein the generation of the electronic horizon include the following steps:
generating a horizon graph including a likeliest path and a plurality of sub-paths; and
generating the electronic horizon by combining data from map elements located in a region of the horizon graph to form data packets.

18. The method as recited in claim 13, wherein, when there are no processed digital map data available in the second method step or when the electronic horizon does not need to be supplied, substitute map data are provided, wherein processing of the substitute map data similarly to the second method step is carried out within the execution time and regardless of the processing time required for processing the digital map data.

19. The method as recited in claim 13, wherein the second method step is monitored.

20. The method as recited in claim 13, wherein a hardware and/or a software lockstep method is used in the first method step.

21. The method as recited in claim 13, wherein the ascertaining of the position of the autonomous motor vehicle includes map matching in which a measured position of the autonomous motor vehicle is allocated to a location in the digital map.

22. The method as recited in claim 13, wherein the second method step is cyclically repeated.

23. A non-transitory machine-readable storage medium on which is stored a computer program including commands for supplying an electronic horizon for an autonomous motor vehicle, the commands, when executed by a computer, causing the computer to perform the following steps:
processing digital map data of a digital map as part of a first method step; and
ascertaining a position of the autonomous motor vehicle and generating, based the processed digital map data, a position-dependent forecast of map elements that are located in front of the autonomous motor vehicle as part of a second method step, as a result of which the electronic horizon is supplied;
wherein the second method step is performed within a predetermined execution time and regardless of a processing time required for the processing of the digital map data.
